(19) United States
(12) Patent Application Publication
(10) Pub. No.: US 2013/0332462 A1
(43) Pub. Date: Dec. 12, 2013

(54) GENERATING CONTENT RECOMMENDATIONS

(71) Applicants: David Paul Billmaier, Woodinville, WA (US); Jason Christopher Hall, Seattle, WA (US); Alexander Charies Barclay, Seattle, WA (US); John Max Kellum, Seattle, WA (US); Henry Hideyuki Yamamoto, Issaquah, WA (US)

(72) Inventors: David Paul Billmaier, Woodinville, WA (US); Jason Christopher Hall, Seattle, WA (US); Alexander Charies Barclay, Seattle, WA (US); John Max Kellum, Seattle, WA (US); Henry Hideyuki Yamamoto, Issaquah, WA (US)

(21) Appl. No.: 13/494,320

(22) Filed: Jun. 12, 2012

(51) Int. Cl. G06F 17/30

(52) U.S. Cl. 707/741; 707/E17.002

(57) ABSTRACT

A system to generate content recommendations by identifying content and selecting a content entry for the content. The system comprises identifying a keyword in the content entry, generating a tag for the content based on the keyword, generating a plurality of recommendations based on the tag, and displaying the recommendations.

### BACKGROUND

The introduction of social networking has transformed the manner in which people communicate, share experiences, and exchange information via the Internet. The transformation has led to people sharing an increasing amount of content and content information through applications and websites. To help users find relevant content and content information, many applications and websites provide content recommendations. The recommendations can assist users in locating related content that is similar to previously accessed content. However, content recommendations are often generated from teams of experts. For example, recommendations for audio content can be generated by categorizing a song according to predetermined categories and recommending other songs within the same category. However, the predetermined categories can be static and unable to be rapidly modified. Furthermore, the recommendations can be based on the input of a relatively small number of individuals.

### BRIEF DESCRIPTION OF THE DRAWINGS

The following detailed description may be better understood by referencing the accompanying drawings, which contain specific examples of numerous objects and features.

FIG. 1 is a block diagram of an example of a computing system for generating content recommendations.

FIG. 2 is a process flow diagram of an example method for generating content recommendations.

FIG. 3 is an example content entry.

FIG. 4 is a process flow diagram of an example method for generating a theme for a playlist.

FIG. 5 is a block diagram depicting an example of a tangible, non-transitory computer-readable medium that stores a protocol adapted to generate content recommendations.

### DETAILED DESCRIPTION OF SPECIFIC EXAMPLES

The techniques for generating content recommendations described herein can utilize content entries to identify information related to content. Content, as referred to herein, includes audio media, video media, audio books, or any other content. The content entries, as referred to herein, include any website or application that allows users to add, modify, or delete information pertaining to a wide variety of topics. For example, a content entry may include a wiki entry that allows users to add, modify, or delete information pertaining to the subject matter of the wiki entry. Since the content entries are generated and maintained by users, the information stored in the content entries can be continuously updated. Therefore, the content entries allow for a dynamic source of information that can be utilized for generating recommendations.

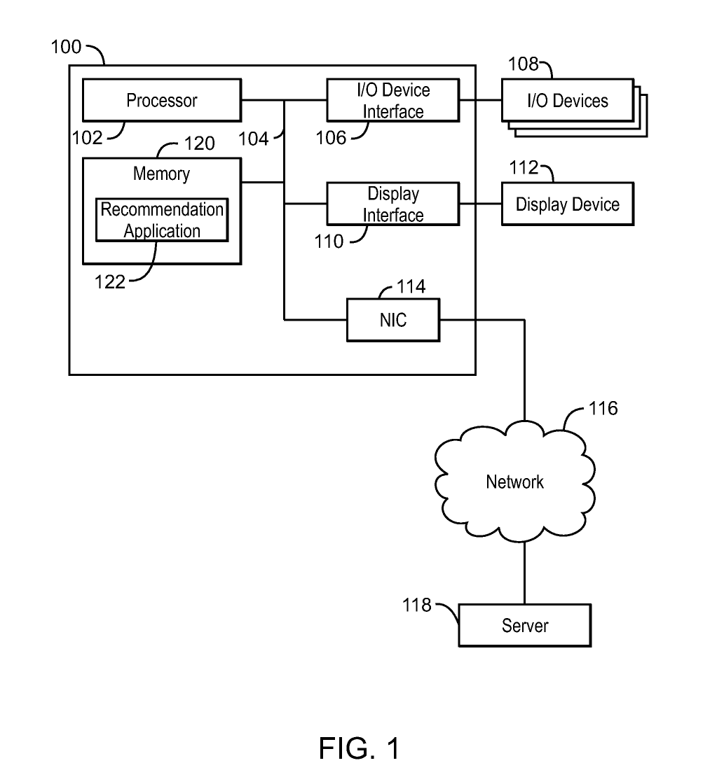

FIG. 1 is a block diagram of an example of a computing system that may be used for generating content recommendations. The computing system 100 may be, for example, a mobile phone, laptop computer, desktop computer, or tablet computer, among others. The computing system 100 includes a processor 102 that is adapted to execute stored instructions. The instructions that are executed by the processor 102 may be used to implement a method that includes generating content recommendations.

The processor 102 may be connected through a system bus 104 (e.g., PCI, PCI Express, HyperTransport®, Serial ATA, among others) to an input/output (I/O) device interface 106 adapted to connect the computing system 100 to one or more I/O devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the system bus 104 to a display interface 110 adapted to connect the computing system 100 to a display device 112. The display device 112 may include a display screen that is a built-in component of the computing system 100. The display device 112 may also include a computer monitor, television, or projector, among others, that is externally connected to the computing system 100.

A network interface card (NIC) 114 may be adapted to connect the computing system 100 through the system bus 104 to a network 116. The network 116 may be a wide area network (WAN), local area network (LAN), or the Internet, among others. Through the network 116, the computing system 100 may retrieve information located in content entries that are stored on a server 118.

The computing system also includes a memory device 120 that stores instructions that are executable by the processor 102. The processor 102 can be a single core processor, a multi-core processor, a computing cluster, or any number of other configurations. The memory device 120 can include random access memory (e.g., SRAM, DRAM, SONOS, eDRAM, EDO RAM, DDR RAM, RRAM, PRAM, among others), read only memory (e.g., Mask ROM, PROM, EPROM, EEPROM, among others), flash memory, or any other suitable memory systems. The memory device 120 may also include a hard drive, an optical drive, a USB flash drive, an array of drives, or any combinations thereof. The memory device 120 may include a recommendation application 122 that is adapted to generate content recommendations as described herein. The recommendation application 122 may obtain recommendation data from the server 118 and I/O devices 108, among other hardware devices. Recommendation data, as described herein, includes any information stored in a content entry, information received by an I/O device 108, or any other information that can be used to generate content recommendations. The server 118 can create, send, and store content entries or any other information related to content.

It is to be understood that the block diagram of FIG. 1 is not intended to indicate that the computing system 100 is to include all of the components shown in FIG. 1. Rather, the computing system 100 can include fewer or additional components not illustrated in FIG. 1 (e.g., video cards, audio cards, additional network interfaces, etc.). Furthermore, any of the functionalities of the recommendation application 122 may be partially, or entirely, implemented in hardware and/or in the processor 102. For example, the functionality may be implemented with an application specific integrated circuit, in logic implemented in the processor 102, in a co-processor on a peripheral device, or any other hardware device.

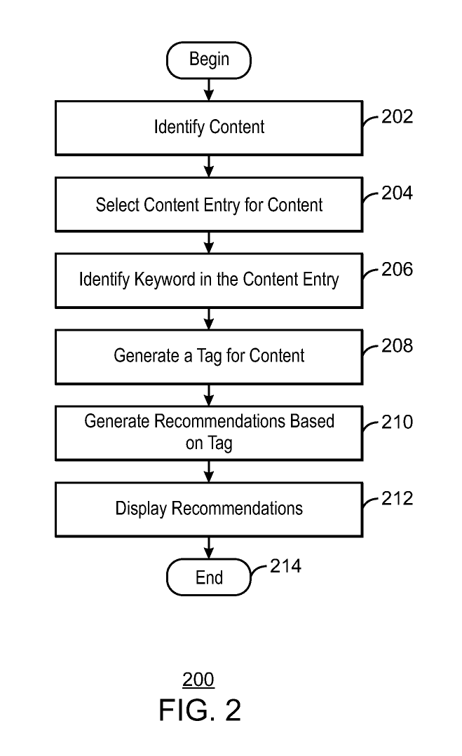

FIG. 2 is a process flow diagram of an example method for generating content recommendations. The method 200 may be used to generate content recommendations by using a computing system with a recommendation application, such as the computing system 100 described with respect to FIG. 1. The computing system 100 may identify content related information from a server 118 and use the content related information to generate recommendations for content.

At block 202, the recommendation application 122 of FIG. 1 identifies content. As discussed above, content can include any audio media, video media, audio books, or any other content. Examples of content include songs, music artists, and videos. The content can be identified using a variety of techniques. For example, the recommendation application 122 may identify a particular song that a user frequently accesses. The recommendation application 122 may then identify the song as content for which recommendations are to be provided. In other examples, additional applications may identify content that is frequently accessed, and send information describing the content to the recommendation application 122. For example, applications may send the name of an audio book to the recommendation application 122 whenever a user has listened to a majority of the audio book. The recommendation application 122 can then provide recommendations for similar audio books.

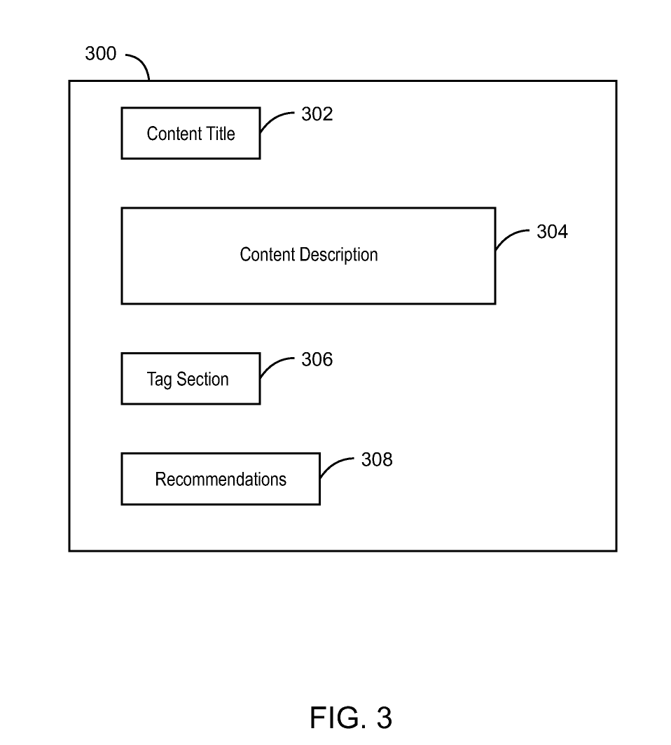

At block 204, the recommendation application 122 selects a content entry for the identified content. As discussed above, a content entry includes websites or applications that allow users to add, modify, or delete information. The content entry for the content can be located by searching a content source, which includes any number of content entries related to any number of topics. For example, a search of a wiki source based on the name of a music artist can identify the wiki entry for the music artist. The information included in the wiki entry can include biographical information, related music artists, types of music performed by the music artist, band members, awards, and other information related to the music artist. An example of a content entry is provided in FIG. 3 and discussed in greater detail below.

At block 206, the recommendation application 122 identifies keywords in the content entry. The keywords can indicate categorical information about the content of the content entry. For example, keywords in a wiki entry can indicate genres of music that a music artist has performed. The keywords can be located in various sections within the wiki entry, such as a content description section. The content description section may contain biographical information related to the content. In some examples, keywords can be identified based on the number of times certain terms are repeated. For example, the word, “country,” may be identified as a keyword if “country” is repeated a specified number of times in a content entry. In some examples, the keywords can be stored in a data structure, such as a linked list, array, or vector, among others.

The keywords in a content entry can also be identified based on user preferences. For example, users may indicate that different keywords have varying degrees of importance. In this example, user preferences may be stored in the computing system 100. The user preferences can also indicate a weighted average for various keywords. The weights used in the weighted average can be assigned to keywords that pertain to broader categories, e.g., music genres, subgenres, awards, discographies, band members, among others. For example, keywords that identify genres of music that a music artist has performed may receive a larger weight than keywords that identify awards the music artist has won. Therefore, the genres of music that a music artist has performed may influence a recommendation more than other keywords that receive smaller weights.

In some examples, multiple content entries may include information relating to the same content. For example, one wiki entry may include information related to content that a second wiki entry does not include. Since the separate wiki entries may contain different information, different keywords can be identified in separate wiki entries. The keywords may then be combined to provide one set of identified keywords.

At block 208, the recommendation application 122 generates a tag for the content based on the keywords. The tag can provide a classification for the content based on any number of the identified keywords. The tag can include a genre of music, a name of a music artist, or a subgenre of music, among others. For example, keywords for a music artist can indicate the music artist is a jazz musician from the 1940's. Therefore, the tag can include a jazz music classification along with a 1940's classification, which provides a type of related music from a specific time period.

In some examples, the tag can be generated by applying user preferences to the identified keywords. For example, a user's preference can indicate the user is interested in audio media recommendations that are from the same genre of music and include music artists with common band members. Accordingly, a tag can be generated to include keywords that relate to the genre of music and band members for audio content. In other examples, a user may seek recommendations for music artists that sound similar to a particular music artist. The recommendation application 122 may identify a number of keywords for the music artist related to a genre of music, a time period, band members, and awards, among others. However, the user preferences may indicate that specific categories of keywords are to be included in a tag, while excluding other keywords. In this way, the tag can be based on a user's preferences. Once the tag is generated, the tag can be stored in the content entry as discussed in greater detail below in relation to FIG. 3. In other examples, the tag may be stored in a computing system.

At block 210, the recommendation application 122 identifies recommendations based on the tag. For example, a tag can indicate that a music artist performs rock music. Accordingly, recommendations based on this tag may include rock musicians. In some examples, a set of potential recommendations can be generated based on a content description of a wiki entry. For example, a song may be identified as belonging to a genre of music. The genre of music can then be used to locate similar songs that represent potential recommendations.

A set of actual recommendations can then be selected from the potential recommendations. In some examples, the tag can include user preferences that indicate the related content that is to be included in the actual recommendations. For example, a user may specify a preference for a specific subgenre of music. As such, a potential recommendation list of blues music can be narrowed to a subgenre of blues, such as electric blues. In other examples, a music artist may perform a particular song that belongs to a different genre of music than the music artist typically performs. While the potential recommendations may include music artists related to the genre of music the music artist typically performs, the tag for the particular song may indicate that music artists of a different genre are to be included in the actual recommendations. In this way, the actual recommendations may be a subset of the potential recommendations.

The potential and actual recommendations can be stored in any type of data structure including a linked list, binary tree, or array, among other data structures. In some examples, the potential and actual recommendations can be stored in the server along with the tags and content entries. In other examples, the potential and actual recommendations can be stored in a computing system.

At block 212, the recommendation application 122 displays the recommendations. In some examples, recommendations are specific to a user and displayed by the recommendation application 122 on a computing system. In these examples, the recommendations may be displayed proximate to the content for which the recommendations are based. For example, the recommendations may include a list of similar songs that belong to the same genre as a particular song. The list of similar songs included in the recommendations may be displayed near the song for which the recommendations are based. In other examples, the recommendations can be added to the content entry, so that other users can use the recommendations. For example, the recommendations may include music artists that perform music in the same genre as a particular music artist. The recommendations may be displayed in a content entry in a recommendation section that displays user specific recommendations that have been generated and stored on a server. In these examples, users can browse the recommendations that have been generated for other users based on their preferences. The process ends at block 214.

The process flow diagram of FIG. 2 is not intended to indicate that the steps of the method 200 are to be executed in any particular order, or that all of the steps of the method 200 are to be included in every case. Further, any number of additional steps may be included within the method 200, depending on the specific application. For example, the method 200 may include searching multiple wiki sources for keywords and aggregating the keywords found in each of the wiki sources. Recommendations can then be identified based on a tag that is generated from the aggregated keywords.

FIG. 3 is an illustration of an example content entry 300. As discussed above, the content entry can include any website or application that allows users to add, modify, or delete information pertaining to a wide variety of topics. The content entry can include various sections such as a content title 302, a content description 304, a tag section 306, and recommendations 308, among other sections. The content title 302 represents the subject matter of the content entry 300. For example, a content title 302 may include the name of a song for which the content entry includes information. The content description 304 can include information related to the subject matter of the content entry 300. For example, the content description 304 can include biographical information for a rock band, such as a discography, or a list of previous band members. The tag section 306 includes tags generated by any number of users. As discussed with respect to FIG. 2, each tag for the same content entry may be different because the tags are based on keywords that can be user-specific. The recommendations section 308 includes recommendations that have been generated for various users. The recommendations can also be user-specific because the recommendations are based on tags, which can include user preferences.

The block diagram of FIG. 3 is for illustrative purposes only and can store and display data in any number of different configurations. For example, additional sections can be stored and displayed on a server 118. In some examples, a content management tab may be included in the content entry to allow privileged users to manage the content entry 300. Other sections not shown in FIG. 3 may be added to the content entry 300, depending on the specific application.

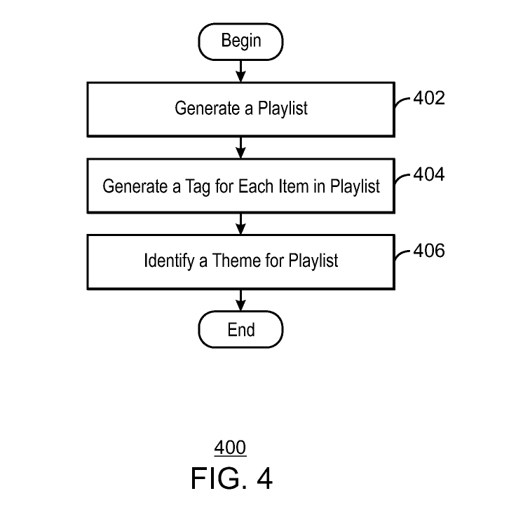

FIG. 4 is a process flow diagram depicting an example of a method for providing a theme for a playlist. The method 400 may be used to provide a theme for a playlist by using a computing system, such as the computing system 100 described in FIG. 1. The computing system 100 may identify content related information from the server 118 and use the content related information to provide a theme for a playlist.

At block 402, the recommendation application 122 generates a playlist. The playlist can include a variety of different content. For example, a playlist can include any number of songs by various music artists or other forms of visual or audio media. The playlist can be generated by the recommendation application 122, or any other application or user. For example, the playlist can be created by randomly selecting songs from a particular time period or genre of music.

At block 404, the recommendation application 122 generates a tag for each item in the playlist. An item can be any type of content such as audio media or video media. In some examples, a content entry is detected for each item, as discussed above in relation to FIG. 2. A tag can then be generated for each item based on keywords identified in content entries. For example, the tags can indicate a genre of music, a time period, or common band members, among other content related information. The tags can then be stored in a computing system, or in a content entry.

At block 406, the recommendation application identifies a theme for the playlist. For example, the tags for each item of the playlist may share a common genre of music such as rock. Therefore, the playlist can be identified as a rock playlist. In other examples, the tags for each item of the playlist may indicate the time period of the music. Therefore, the playlist may be identified as a 1970's playlist that includes music from various genres of music from the 1970's time period.

The process flow diagram of FIG. 4 is not intended to indicate that the steps of the method 400 are to be executed in any particular order, or that all of the steps of the method 400 are to be included in every case. Further, any number of additional steps may be included within the method 400, depending on the specific application. For example, the method 400 may also store previously generated playlists in content entries that relate to songs included in the playlist. In this way, users can browse previously generated playlists that may relate to recommended content.

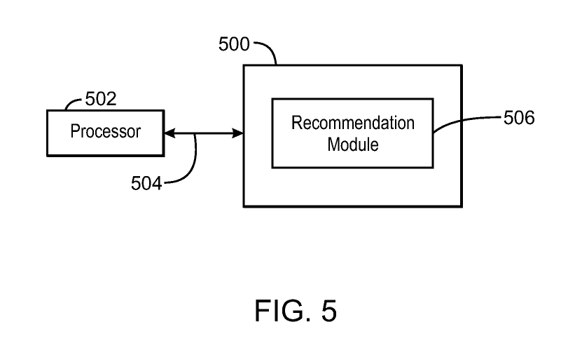

FIG. 5 is a block diagram showing a tangible, non-transitory, computer-readable medium 500 that generates content recommendations. The tangible, non-transitory, computer-readable medium 500 may be accessed by a processor 502 over a computer bus 504. Furthermore, the tangible, non-transitory, computer-readable medium 500 may include code to direct the processor 502 to perform the steps of the current method.

The various software components discussed herein may be stored on the tangible, non-transitory, computer-readable medium 500, as indicated in FIG. 5. For example, a recommendation module 506 may be adapted to direct the processor 502 to generate recommendations for content. It is to be understood that any number of additional software components not shown in FIG. 5 may be included within the tangible, non-transitory, computer-readable medium 500, depending on the specific application.

The present examples may be susceptible to various modifications and alternative forms and have been shown only for illustrative purposes. Furthermore, it is to be understood that the present techniques are not intended to be limited to the particular examples disclosed herein. Indeed, the present techniques include all alternatives, modifications, and equivalents falling within the true spirit and scope of the appended claims.

What is claimed is:

1. A method for generating content recommendations comprising:
identifying content;
selecting a content entry for the content;
identifying a keyword in the content entry;
generating a tag for the content based on the keyword;
generating a plurality of recommendations based on the tag; and
displaying the recommendations.

2. The method of claim 1 further comprising:
generating a playlist of content comprising a plurality of items;
generating a plurality of tags, wherein each of the tags corresponds to an item; and
identifying a theme of the playlist of content based on the tags.

3. The method of claim 1, wherein the content comprises audio content.

4. The method of claim 3, wherein generating the recommendations based on the tag comprises identifying related audio content comprising at least one common characteristic with the content.

5. The method of claim 1, wherein identifying the keyword in the content entry comprises:
searching the content entry for a term; and
determining the term is repeated a specified number of times.

6. The method of claim 1, wherein generating the recommendations based on the tag comprises:
identifying a plurality of potential recommendations;
selecting a portion of the potential recommendations; and
identifying the portion of the potential recommendations as a set of actual recommendations.

7. The method of claim 1, comprising storing the tag for the content in the content entry.

8. The method of claim 1, wherein identifying the keyword in the content entry comprises:
determining a user preference; and
identifying the keyword based on the user preference.

9. A system comprising:
a network interface card to select a content entry from a server through a network;
a display device to display content and the content entry;
a memory device to store a recommendation application, wherein the recommendation application is to generate content recommendations; and
a processor to:
identify content;
select a content entry for the content;
detect a user preference;
identify a keyword based on the user preference;
generate a tag for the content based on the keyword;
generate a plurality of recommendations based on the tag; and
display the recommendations.

10. The system of claim 9, wherein the processor executable code also causes the processor to:
generate a playlist of content comprising a plurality of items;
generate a plurality of tags, wherein each of the tags corresponds to an item; and
identify a theme of the playlist of content based on the tags.

11. The system of claim 9, wherein the content comprises audio content.

12. The system of claim 11, wherein the processor executable code also causes the processor to identify related audio content comprising at least one common characteristic with the content.

13. The system of claim 9, wherein the processor executable code also causes the processor to:
search the content entry for a term; and
determine the term is repeated a specified number of times.

14. The system of claim 9, wherein the processor executable code also causes the processor to:
identify a plurality of potential recommendations;
select a portion of the potential recommendations; and
identify the portion of the potential recommendations as the plurality of actual recommendations.

15. A tangible, non-transitory, computer-readable medium comprising code to direct a processor to:
identify content;
select a content entry for the content;
detect a user preference;
identify a keyword based on the user preference;
generate a tag for the content based on the keyword;
generate a plurality of recommendations based on the tag; and
display the recommendations.

16. The tangible, non-transitory computer-readable medium of claim 15 comprising code to also direct a processor to:
generate a playlist of content comprising a plurality of items;
generate a plurality of tags, wherein each of the tags corresponds to an item; and
identify a theme of the playlist of content based on the tags.

17. The tangible, non-transitory computer-readable medium of claim 15, wherein the content comprises audio content.

18. The tangible, non-transitory computer-readable medium of claim 17 comprising code to also direct a processor to identify related audio content comprising at least one common characteristic with the content.

19. The tangible, non-transitory computer-readable medium of claim 15 comprising code to also direct a processor to:
search the content entry for a term; and
determine the term is repeated a specified number of times.

20. The tangible, non-transitory computer-readable medium of claim 15 comprising code to also direct a processor to:
identify a plurality of potential recommendations;
select a portion of the potential recommendations; and
identify the portion of the potential recommendations as the plurality of actual recommendations.
